(19) United States
(12) Patent Application Publication
(10) Pub. No.: US 2005/0237150 A1
(43) Pub. Date: Oct. 27, 2005

(54) Method and key for adjusting driver-specific parameters in a vehicle and a corresponding vehicle

(76) Inventors: Hao Sun, Braunschweig (DE); Thomas Furstnow, Braunschweig (DE); Martin Wiel, Dresden (DE); Heino Wengelnik, Wolfsburg (DE); Martin Grade, Wolfsburg (DE); Jens Fliegner, Wahrenhold (DE)

Correspondence Address: Andreas Grubert;Baker Botts, L.L.P., One Shell Plaza, 910 Louisiana, Houston, TX, 77002-4995, US

(21) Appl. No.: 11/117,748

(22) Filed: Apr. 28, 2005

Related U.S. Application Data
(63) Continuation of application No. PCT/EP03/12411, filed on Nov. 6, 2003.

(30) Foreign Application Priority Data
Nov. 7, 2002 (DE) 102 51 858.0
Sep. 1, 2003 (DE) 103 40 184.9

(51) Int. Cl. G06F 7/04

(52) U.S. Cl. 340/5.52; 340/5.61; 340/5.53; 340/5.72; 340/426.15; 340/426.22; 701/49

(57) ABSTRACT

Numerous parameters in a vehicle (1), for example, adjustment of the driver seat and rearview mirror. To increase operating comfort for a driver, it is proposed according to the invention that a key (2), assigned to a vehicle (1), determines a biometric feature, especially a fingerprint, of a driver and sends personalization information depending on it to a control device (8) of a vehicle (1). By means of this personalization information, the control device (8) can carry out driver-specific adjustments within a vehicle (1) before the driver gets into the vehicle (1). In addition, the personal desires of an almost unlimited number of drivers can be considered with only a single key (2), as long as the information required for recognition of the different drivers is stored in the key (2), as well as the adjustments desired by the individual drivers.

### CROSS REFERENCE TO RELATED APPLICATION

This application is a continuation of copending International Application No. PCT/EP2003/012411 filed Nov. 6, 2003 which designates the United States, and claims priority to German application no. 102 51 858.0 filed Nov. 7, 2002 and German application No. 103 40 184.9 filed Sep. 1, 2003.

### TECHNICAL FIELD OF THE INVENTION

The present invention concerns a method and a key for adjusting at least one driver-specific parameter of a vehicle, as well as a correspondingly equipped vehicle.

### DESCRIPTION OF THE RELATED ART

The key of a vehicle is now used not only to lock the door and operate the ignition lock, but ordinarily additionally serves for wireless activation or deactivation of an immobilizer and/or for opening and closing of a central locking device of the vehicle. In addition, the key is the only part of the vehicle that a driver takes with him after parking of the vehicle and connects him to the vehicle.

For example, a vehicle with a key that offers expanded communications possibility with the vehicle is known from DE 195 13 498 C1. For example, the key can receive radio messages of the vehicle and notify them to the driver. A key unit is also known from U.S. Pat. No. 6,386,007 B1, by means of which the driver can determine the direction, in which the vehicle is positioned, viewed from the key, in order to easily be able to find his vehicle again after parking.

A vehicle key system with a key, having a fingerprint sensor, in order to permit use of the key by authorized persons only, is also known from DE 190 47 967 A1. To increase security, a mounting unit is also provided within the vehicle, in which the key is arranged in the mounting unit, in order to prevent the vehicle from being used to transmit appropriate data without the key, which, for example, were obtained by intercepting proper data transmission between the key and vehicle.

In the aforementioned systems, it is a disadvantage that only startup of the vehicle is made possible without further adjustments of individual persons. Essential attention on the corresponding driver does not occur.

### SUMMARY OF THE INVENTION

The present invention is therefore based on the task of devising a method and key for adjusting driver-specific parameters of a vehicle, in which increased operating comfort for the driver is adjusted and, if possible, the fewest possible actions of the driver are required, in order to adjust the vehicle to his desires.

This task can be solved by a method for adjusting at least one operating person-specific parameter of a vehicle as a function of an operating person, comprising the steps of sending personalization information of the operating person by a key of the vehicle to a control device of the vehicle, and adjusting at least one parameter of the vehicle by the control device as a function of the received personalization information.

The method may also comprise the step of determining the personalization information by determining and evaluating a biometric feature of the operating person. The biometric feature of the operating person can be a fingerprint and/or an acoustic feature of the speech of the operating person and/or an optical feature of the iris of the operating person. The parameter of the vehicle to be adjusted can be the adjustment of a seat, especially the driver's seat, and/or the adjustment of a mirror and/or a selection of transmitters stored in a radio receiver and/or acoustic adjustments of a music playback device and/or a parameter that influences the response behavior of the engine to control interventions of the operator. The at least one operating person-specific parameter of the vehicle can only be adjusted if a central locking device of the vehicle is unlocked by means of a locking activation element of the key, and/or an immobilizer of the vehicle is deactivated.

The task can also be solved by a key that can be configured, so that it sends personalization information of an operating person to a control device of the vehicle, and that the control device adjusts at least one parameter of the vehicle as a function of the received personalization information.

The key can be configured, so that it determines the personalization information by determining and evaluating a biometric feature of an operating person. The key can be configured so that it stores the personalization information. The key can be configured so that the key sends the personalization information to the vehicle as soon as a communications connection is made between key and the vehicle. The key may have a locking activation element to lock or unlock a central locking device in the vehicle and/or for activation or deactivation of an immobilizer of the vehicle. The key can be configured so that it determines the biometric feature and therefore the personalization information and sends it to the vehicle, if the locking activation element is operated. The locking activation element may include a fingerprint sensor, and the key can be configured, so that during operation of the locking activation element, a fingerprint is determined as diametric feature of the operating person by a fingerprint sensor. The key can be configured so that the key determines information concerning the direction, in which the vehicle is located, viewed from the key, and displays the determined direction information. The alignment of a bit of the key can be used as reference direction of the key. The key can be configured so that the key determines information concerning direction, in which the vehicle is located from the key only during activation of a vehicle locating activation element. The key can be configured so that it sends the personalization information to the vehicle in wireless fashion, via contact connection, via inductive coupling or via a light signal. The key can be configured so that it can receive status data from the vehicle. The status data may include the mileage of the vehicle and/or the filling of the fuel tank of the vehicle and/or information concerning whether unauthorized persons have entered the vehicle and/or operated it and/or information as to whether the vehicle is being moved or towed. The key may comprise a display to display the status data and a button, wherein the button is configured, so that the display can be activated by pressing the button. The key can be configured so that on first pressing of the button that indicates information concerning the general status of the vehicle. The key can be configured so that the information concerning the general status of the vehicle is information as to whether all status data is satisfactory or not, and includes an indication concerning a name corresponding to the personalization information that is stored in the key. The key can be configured so that pressing of a button, when display is activated, causes the display to indicate a different part of the status data sent to the key from vehicle with each pressing, in which, on repeated pressing of the button, all the status data sent from the vehicle are indicated on the display in succession. The key can be configured so that different security steps are adjustable in key, which stipulate the dependence on a determined biometric feature, in which the operating person can perform operating activities. The key can be configured so that the key has an interface, by means of which a biometric feature with corresponding personalization information can be sent to the key. The key can be configured so that the key has an interface, by means of which the personalization information can be transmitted to the key, and that the key in this case stores the transmitted personalization information. The vehicle and the key may have means of transmission and receipt for data transmission and are set up, so that the key sends personalization information of the operating person to a control device of the vehicle, and the control device may adjust the at least one parameter of the vehicle as a function of the received personalization information. The vehicle can be configured so that the vehicle with the key has a communications connection, when the vehicle recognizes that a handle of the vehicle is operated. The vehicle can be configured so that it transmits status data to the key. The vehicle can be configured so that it sends status data to the key at certain time intervals. The vehicle can be configured so that the status data are transmitted at the time of stopping of the vehicle or when the operating person gets out. The vehicle may send status data in wireless fashion, by contact connection, inductive coupling or light signals. The vehicle and the key can be set up to execute a method comprising the steps of ending personalization information of the operating person by a key of the vehicle to a control device of the vehicle, and adjusting at least one parameter of the vehicle by the control device as a function of the received personalization information. The means of transmission and receipt of the vehicle and the key can be equipped for wireless data transmission.

According to the invention, the key of the vehicle determines a biometric feature of the driver, sends personalization information of the driver to the vehicle or a control device in the vehicle, whereupon driver-specific parameters of the vehicle are set as a function of the personalization information. The key can then transmit the personalization information to the vehicle in wireless fashion, via a contact connection, inductive coupling or via light signals or the light.

This enjoys the advantage that different keys with different codes are not required for driver-specific adjustment of parameters of the vehicle, but an arbitrary number of different drivers with different preferences or adjustment desires can be considered with a single key.

For example, the fingerprint of the driver, an optical feature of the iris of the driver, or a speech pattern of the driver, can be considered as biometric features. Preferably, the fingerprint of the driver is used, since this can be determined without an adverse effect from optical or acoustic surrounding influences.

The biometric feature of the driver is determined in each case, when he intends to open and/or operate the vehicle by means of the key. On this occasion, data from the key are generally sent to the vehicle anyway, so that the personalization information can additionally be transmitted. In addition, the need to carry out driver-specific adjustments generally only exists from this point.

However, it can also be provided according to the invention that determination of the biometric feature of the driver and therefore determination of the actual personalization information be its own step, which is not repeated in each case when the vehicle is to be opened and/or operated by means of the key. Since determination of the biometric feature and comparison with the existing biometric features, under some circumstances, is time-consuming or prone to error, it is useful not to repeat this step every time the vehicle is to be opened and/or operated by means of the key. Another advantage of separation of this step is justified by the fact that the key can also convey the actual personalization information to the vehicle when the operating person is not in contact with the key. It is therefore possible for the vehicle to be opened and, for example, an immobilizer deactivated, without the authorized driver touching the key (keyless entry).

It can also be provided that the actual personalization information can also be conveyed via its own interface to the key, so that the key can advantageously be personalized even without determination of a biometric feature, and can also be personalized for a driver, whose biometric feature is not stored in the key, i.e., in this case, the personalization information is notified to the key by programming.

It can also be provided that the key have a locking activation element, with which the driver opens or closes the central locking device and/or activates or deactivates an immobilizer. When the driver intends to use the vehicle, he will generally use the locking activation element anyway (if the vehicle does not have a system with keyless entry, see above), so that, on this occasion, the biometric feature of the driver can be determined. The locking activation element advantageously includes a fingerprint sensor. As soon as the driver places his finger, as usual, on the locking activation element, in order to open the vehicle or deactivate the immobilizer, the fingerprint can be automatically determined in this way and personalization information of the driver, who intends to use the vehicle next, obtained. Before the driver gets in, driver-specific parameters of the vehicle can therefore be set as a function of the driver.

These parameters can be adjustments within the vehicle as a function of the dimensions of the driver, for example, seat adjustments, mirror adjustments, steering wheel adjustments, etc. These adjustments can also include a choice of transmitters stored in a radio receiver. The parameters can also concern occupancy of transmitter storage items in a radio receiver.

In a music playback device, the parameters can concern the acoustic adjustments. It is also conceivable that the parameters are person-specific adjustments of a communications system, for example, an address book or telephone number list.

In a modification of the present invention, different security steps can be provided, according to which an operating person is enabled to execute operational actions. The different security steps are adjustable, in particular, in which case they can be adjusted, both via the key itself, and also via operating elements in the vehicle. For example, a security step can be provided, in which all operating actions of each operator are made possible without verification of the biometric feature. If recognition of the biometric feature does not occur, naturally no adjustment of the parameters to the driver occurs. This type of security step can also be referred to as guest mode, if, for example, use of the vehicle is to be made temporarily possible for a short time to a foreign individual without conducting extensive adjustments. In this guest mode, it can also be advantageously provided that all user-specific parameters that are stored in the key and/or in the vehicle are not accessible to the guest, or cannot be called up by him. In addition, the parameters in the guest mode are advantageously set, so that they are suitable for an average operator, especially without prior knowledge about operation of the vehicle. Thus, the driver's seat, the steering wheel and mirror, as well as additional elements to be adjusted to the size and shape of the operating person, are adjusted to an operating person of average size and shape. The same applies for appropriate adjustment possibilities in the reaction to activities on the part of the operator, for example, by means of an electronic gas pedal, etc. An optionally present address book or other collection of personal data of an authorized user is preferably blocked in the guest mode, so that it cannot be viewed by the operating person, who is only to be permitted use of the vehicle temporarily.

In contrast to the guest mode, a user mode can be provided, in which at least some, or also all operating functions are made possible only to a registered user, who has been successfully identified via the biometric feature. As soon as the user has been identified, the identity of the user is known and user-specific adjustments can be made in the vehicle. For example, in this security step, it is also provided that startup of the vehicle only be possible after successful identification of the biometric feature. In a modification of the guest mode, however, it can also be provided that the vehicle also remain usable for unregistered users, in which case no user-specific adjustments are made based on lack of identification of the user, during which adjustments that are suitable for an average user can be made in an unidentified user, just as in the guest mode. Choice of the adjustments that are possible in the user mode only after successful identification can be chosen arbitrarily. Several user modes can also be provided, in which a different selection of functions requires successful identification of the user.

Switching between individual security steps is also advantageously coupled to successful identification of a registered user, in order to prevent unauthorized persons from being able to adjust a security step with lower security. The security mechanisms, during switching of the security step, can then be independent of the correspondingly set security step, so that the same stored procedure is always required in the guest mode and in a user mode, in order to switch the security step. As an alternative, it can also be provided that the security step in the guest mode can be changed, especially to a higher security step of higher security, by each operating person without prior identification. For example, a situation can then be achieved, in which an operating person, who is only to be permitted use of the vehicle temporarily, after use increases the security step and use of the vehicle from this point by unauthorized persons, who cannot be successfully identified, is therefore prevented.

In a preferred variant, an operating person must be successfully identified before changing the security step via recognition of the biometric feature. For example, after the operating person is given access after recognition of a fingerprint, the key is to be set, so that the operating person can quickly change the security step with the fewest possible actions. A situation can therefore be set up, in which an operating person gives the key to an unregistered person, so that he can use the vehicle briefly without this person gaining access to the user-specific data in the vehicle.

In an advantageous modification, the key also includes a device to determine the location of the vehicle. In this case, the direction, in which the vehicle is located, as viewed from the key, is determined. The direction, in which the bit of the key extends is preferably chosen as reference direction. The result of reference determination can be displayed by the key in that an optical display is increased in its intensity, up to a maximum value, as a function of direction, in terms of how much the reference direction of the key coincides with the direction, in which the vehicle is located, as seen from the key. This pointing direction or reference direction is externally indicated on the key and, in particular, agrees with the direction, in which the bit of the key extends. The optical display, for example, can be a light element that increases in intensity, a blinking element that increases in blinking frequency, or also an alphanumeric display. In the case of a blinking indication, blinking can convert to continuous illumination as soon as the pointing direction of the key coincides with the vehicle direction with sufficient accuracy, in which the vehicle is situated, as viewed from the key.

The vehicle direction can also be indicated by means of a moving pointer or a rim of several light elements.

An acoustic message is also conceivable, in which a sound can increase in sound level or intensity, or an acoustic pulse is issued with increasingly smaller distances, in which the pulse sequence can change to a continuous tone as soon as the pointing direction of the key coincides with the vehicle direction with sufficient accuracy.

This type of key can additionally advantageously also include a display for status data of the vehicle. The status display can then also be configured very simply, so that it can display only a few, and especially two different status, and enables the driver to exclusively obtain information whether everything is okay in the vehicle. For example, a two-color light-emitting diode can be provided, which lights green as long as everything is okay in the vehicle, and lights red as soon as a disturbance occurs. A disturbance, for example, can be a break-in attempt, towing away, generally a change in location of the vehicle or damage, for example, to a window.

It is also conceivable to connect the display for locating the vehicle to the status display of the vehicle, in which case a light element indicates whether everything is okay in the vehicle, and on activation of a certain vehicle location activation element, the display assumes the vehicle direction.

The display of the vehicle status preferably does not occur continuously, but at time intervals, in order to discharge a battery of the key as little as possible. Generally, it can be provided for power supply to the key that a rechargeable battery be arranged within the key and be charged, as soon as the key is inserted into the vehicle. Contacts or an inductive coupling by means of coils can be provided within the key for charging the rechargeable battery.

The status data could be, for example, tire pressure, mileage, switching status of the parking light and/or other lights, status of the hand brake, tank filling or filling level of other operating liquids or charge status of the battery.

The status data can also be indicated by a display or issued as a speech message.

The status data can also be transmitted to the key, at least in part, at the time of leaving the vehicle. This can be simply implemented in advantageous fashion technically. For example, status data can be transmitted to the key in this case, as long as it is still inserted into the ignition lock or is still in its vicinity. Transmission can occur by contacts, induction coils or light signals.

The key can be used in the present invention in the usual manner for getting in and driving off. In addition, a biometric authorization for access to the vehicle, and also for personalization of the vehicle, is also conceivable.

With reference to localization of the vehicle, it is also conceivable as an additional invention that either the key or the vehicle itself determines the vehicle position and transmits the position data to a mobile navigation system that the user of the vehicle can take with him. This can be a known GPS system, in which a portable computer, for example a PDA, can be used for navigation. Transmission of the vehicle position can occur on parking of the vehicle, on leaving the vehicle, or also later on demand by the driver, for example, when he wishes to find his way back to the vehicle from his present location.

If the key has an interface (for example, via Bluetooth), data can be both be read out from the key and transmitted to it. On read-out of data, vehicle data can be transmitted from the key to a personal organizer, portable computer or PDA. For example, this works during a shop visit, in order to be able to enter data without access to the vehicle. For example, data can be transmitted in wireless fashion during a service acceptance (conclusion of a service order in a workshop), so that information concerning the vehicle, and optionally also concerning the owner or user, are already available at the workshop. Access to the data stored in the key can then be restricted, depending on the receiver, during which a shop should have access to all data.

In another variant, the possibility can be offered of entering data into the key via the interface, from which data can also be transferred to the vehicle. In this way, the procedure in which a new user is to add his adjustments into the database of the vehicle is facilitated. For example, an operator, who has stored specific adjustments in a first vehicle, can therefore transfer this information to a second vehicle, in which the user-specific information is transmitted from the key of the first vehicle to the key of the second vehicle. This situation can occur, for example, if an operator buys a new vehicle and would like to transfer the information stored in the old vehicle with limited cost. This procedure also works in auto rentals, which case the information of a specific user is stored with the car rental company and transferred during renting of the vehicle to the key by the car rental company before renting, so that the customer, on renting, already has his personal information stored in the rented vehicle.

When the key has both a flat display, as well as a flat sensor, for example, a fingerprint sensor, the key can be configured at least essentially flat, in which case the display is arranged on one side and the flat sensor on the other side. This is possible, since, during activation of the sensor to determine the biometric feature, the display generally need not be used simultaneously, since, during activation of the sensor by the operator, only the acknowledgement is awaited as to whether the identification was successful or not, which is also possible with a small optical element, for example, an LED. By arranging the display on one side and the sensor on the other side, the key can be designed smaller and the surface of the key can be better utilized, in order to be able to accommodate the largest possible display even on a small key.

### BRIEF DESCRIPTION OF THE DRAWINGS

The invention is further described below by means of a preferred practical example with reference to the enclosed drawings. In the drawings

FIG. 1 shows a schematic view of the vehicle with an assigned key (front) according to the practical example of the present invention,

FIG. 2 shows the relative arrangement between they key and the vehicle for determination of the vehicle location, and

FIG. 3 shows the back of the key.

### DETAILED DESCRIPTION OF THE PREFERRED EMBODIMENTS

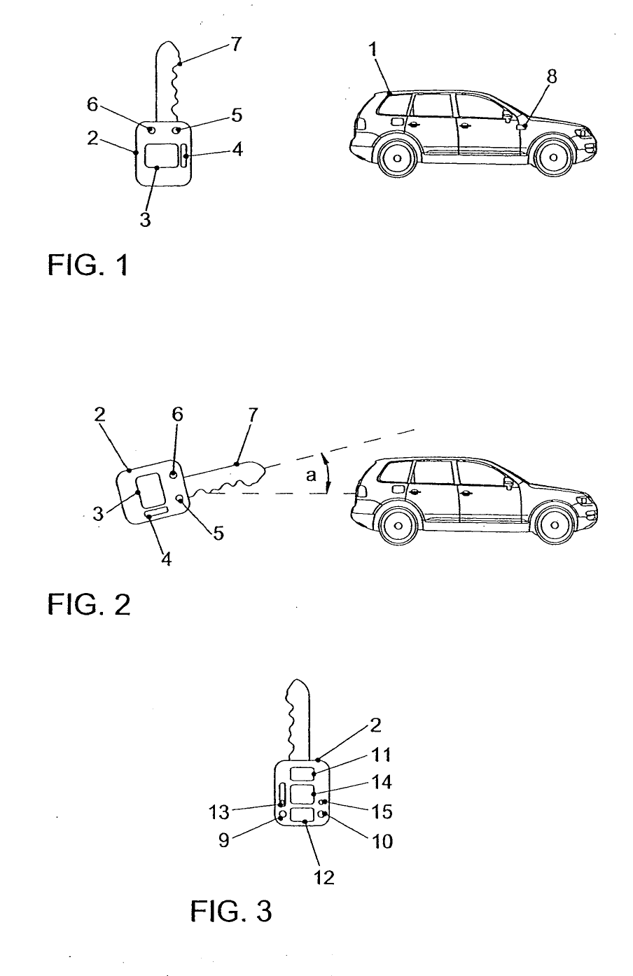

A vehicle 1 is shown in FIG. 1 with an internally incorporated control device 8. In addition, an allocated key 2 is depicted in FIG. 1, in which both the key 2 and the control device 8 have radio transmitters, by means of which wireless data transmission is made possible between key 2 and control device 8.

The key 2 has a locking activation element 3, which is operated by finger pressure and serves to lock or unlock an immobilizer of vehicle 1 and to open or close a central locking device of vehicle 1.

The locking activation element 3 also includes a fingerprint sensor, so that a fingerprint, or at least fingerprint information, can be determined simultaneously during activation of the locking activation element 3 with a finger. As soon as the driver operates the locking activation element 3 in key 2, in order to lock or open the car, fingerprint information is automatically available within key 2. A green light-emitting diode 9 then blinks, when the fingerprint or fingerprint information is known in the key 2, and a red light-emitting diode 10 lights, when no corresponding fingerprint or fingerprint information can be found in the key 2.

The determined fingerprint information is converted in key 2 to personalization information that represents a code for the driver. For this purpose, different fingerprints or fingerprint information of different drives is stored, together with the corresponding personalization information in key 2, so that the individual drivers can be distinguished from each other by means of their fingerprint or fingerprint information. As soon as a certain driver wishes to open vehicle 1, by pressing the locking activation element 3, the driver is recognized by key 2 by means of his fingerprint and personalization information corresponding to the driver is sent to the control device 8 in vehicle 1.

Since determination of biometric features, for example, a fingerprint, and the related comparison to the available fingerprints of fingerprint information can be time-intensive and prone to error, in one variant of this version, it is provided to conduct the step of determining the fingerprint or fingerprint information and the related determination of the corresponding personalization information independently. For this purpose, the driver places his corresponding fingertip into a fingerprint sensor 14, which determines a corresponding fingerprint. As soon as this step, which is also possible, if the vehicle 1 is located outside of the range of key 2, has taken place, the key 2 stores the corresponding current personalization information, which the key 2 sends to the vehicle 1 in all corresponding situations (for example, during activation of the locking activation element 3, which, in this variant, does not include a fingerprint sensor), without having to take a fingerprint again. The drawback that the loss of key 1 in a state, in which the actual personalization information is stored, corresponds to the loss of an ordinary vehicle key is compensated by the following advantages. In the first place, as already mentioned, the sometimes time-intensive and error-prone determination of the fingerprint or fingerprint information and the accompanying matching with existing fingerprints or fingerprint information drops out, when the key 2 is used, in order to open or operate vehicle 1. In addition, it is possible for the key 2 to send the current personalization information to vehicle 1, without the key 2 having been touched beforehand. Because of this, the vehicle 1 is unlocked as soon as the vehicle 1 recognizes that the key 2 with an authorized current personalization information is in the immediate vicinity of vehicle 1 (keyless entry).

In another variant (not shown), the vehicle 1 sends a signal as soon as a handle of the vehicle 1 is grasped or activated. If an authorized key 2 is situated within the range of reception of this signal, this key 2 then sends its current personalization information to vehicle 1.

The learning of a new assignment of a new fingerprint or fingerprint information for a corresponding new personalization information should only be done by the main authorized individual, who must be authenticated beforehand by his fingerprint. Since management of the biometric features and the corresponding personalization information requires complex dialogue, this management (erasing, changing, creation) is not carried out via key 2, but is performed by a corresponding device in vehicle 1, from which the personalization information is then transferred to key 2. A complete recess is then only possible by a shop, which, for example, appears useful during sale of vehicle 1. If management of the assignment of fingerprints or fingerprint information to corresponding personalization information is carried out, the red 10 and green 9 light-emitting diodes of key 2 blink. Naturally, devices to manage the personalization information and transmit the personalization information to key 2 can also be made available outside of vehicle 1, for example in a shop or car rental office.

The information concerning which driver will use the vehicle 1 is present in control device 8 before starting of vehicle 1. By means of this information, the control device 8 sets driver-specific parameters, as stored for the corresponding driver in control device 8. These parameters include, in particular, adjustments of the driver seat, the rearview mirror, transmitter stored in a radio receiver, data of a communications list, telephone numbers of a telephone number list or settings of an air conditioner unit. Since the control device 8 obtains the required personalization information from key 2 for adjustment of driver-specific parameters before the driver gets into vehicle 1, sufficient time remains to carry out mechanical adjustments that require a certain amount of time, for example, adjustment of the driver seat. This has the advantage that the driver seat is already adjusted before the driver gets into the vehicle 1.

By means of a sliding switch 13 (or a sliding key, which is not shown in the present variant), and/or by means of operating elements (not shown) in vehicle 1, it is possible to reset the key 2 in a guest mode. In this case, the actual personalization information in key 2 is overwritten by personalization information corresponding to a guest. The guest rights then include access to vehicle 1 and the right to start the engine. All adjustments in vehicle 1 that the guest carries out are not stored. Any authorized operating person can convert key 2 back to personal key 2 at any time by applying his fingerprint to key 2.

Key 2 also has a vehicle locating activation element 4, with which a special function key 2 can be activated, according to which a vehicle direction can be determined, in which the vehicle 1 is located, when viewed from key 2. It is then determined within key 2 the extent, to which a pointing direction, which is determined with reference to the housing of key 2, agrees with the vehicle direction, in which the vehicle 1 is situated, as seen from key 2. The pointing direction of key 2 is preferably to the direction, in which a bit 7 of key 2 extends. The degree of agreement between the pointing direction and the vehicle direction is indicated by a vehicle direction display element 5. The vehicle direction display element 5 is a light-emitting diode that emits light signals that are spaced in time or blinks. The better the pointing direction and the vehicle direction agree, the more rapid the blinking frequency of the vehicle direction display element 5, in which blinking grades into permanent illumination, when the pointing direction and the vehicle direction agree within a certain accuracy.

If the driver of vehicle 1 parks it and moves away from it, he can at least determine the direction in which the vehicle 1 is situated, from the standpoint of key 2, by pressing on the vehicle location activation element 4 on key 2. For this purpose, the driver need only pivot key 2 with the vehicle location activation element 4 pressed down, until the light signals of the vehicle direction display element 5 turn into permanent illumination. As soon as this is the case, the bit 7 points in the direction in which the vehicle 1 is located.

In addition, key 2 is capable of displaying and reporting, via a microphone 15, a brief voice indication (for example, of 30 seconds). It is possible on this account, for example, to store the parking location of vehicle 1 as speech recorded as a memory aid, and to listen to it, as required.

The key 2 also has a display 11 and a status display 6. The status display 6 is a light-emitting diode and indicates whether everything is okay in vehicle 1. On the other hand, display 11 provides detailed information concerning vehicle 1 and displays the following:
Parking light (status)
Find tank filling
Vehicle alarm active (yes/no)
Time of next maintenance
Marking of the vehicle (license plate)
Tire pressure
Battery charge status
Mileage
Locking state

Switching then occurs between the individual status information via repeated pressing (toggling) of an information button/key 12, in which the display 11 is activated during first pressing of information button/key 12, and indicates, as first higher level information, which includes the current access authorizations and brief information concerning the general vehicle condition. The general vehicle status is indicated with a “Smile” ( [symbol] ), if the information present in key 2 concerning vehicle 1 attests that everything is satisfactory. If the information button/key 12 is no longer operated for a certain time, display 11 goes off.

In addition, different possible disturbances are monitored by control device 8, for example, damage to vehicle 1, a break-in attempt, a location change of vehicle 1, or whether vehicle 1 has been towed. As soon as one of the monitored disturbances occurs, the control device 8 recognizes a disturbance. A control device 8 therefore distinguishes between a proper status and a disturbed status and indicates this in key 2 by means of status display 6. It can then be provided that the control device 8 sends signals to key 2, as long as the vehicle 1 is in the proper status, so that the key 2 indicates the disturbance in the absence of these signals. This has the advantage that during interruption of radio connection between key 2 and control device 8, the proper status is not incorrectly indicated.

On the other hand, the control device 8, however, can also exclusively indicate the disturbance in key 2, so that, in the absence of such information, the proper status is displayed by key 2. Moreover, these is also a possibility that the control device displays both the proper status and the disturbed status in key 2, so that it can display reliably both statuses and, as a third status, an interruption of radio connection.

To display the different statuses by means of status display 6, there are different possibilities. For example, the status display 6 can be a two-color light-emitting diode, in which one color each is assigned to the proper status of the disturbed status. In order to consume as little energy as possible, the status display 6 can also display the corresponding status by means of brief light flashes. An interruption of radio connection, for example, can be indicated by a more rapid blinking frequency or alternating blinking of the two colors. Likewise, the different statuses of proper status, interference and interruption of the radio connection can be displayed by status display 6 by different blinking frequencies.

There is also the possibility of combining the status display 6 and the vehicle direction display 6 in a single display element (perhaps display 11), which indicates the vehicle direction, when the vehicle location activation element 4 is held down, and becomes the status display, when the vehicle location activation element 4 is not pressed.

The relative arrangement of key 2 in vehicle 1 during determination of vehicle direction is schematically shown in FIG. 2. The pointing direction of key 2 is shown by means of a dash-dot line and the vehicle direction by means of a dashed line. The vehicle direction and the pointing direction enclose the angle α, which is determined by key 2. Depending on the determined angle α, control of the vehicle direction display element 5 occurs. The angle α has a value range from 0 to 180°, so that, by means of the vehicle direction display 5, it cannot be distinguished whether the pointing direction runs past vehicle 1 to the left or right at an angle α different from zero.

1. A method for adjusting at least one operating person-specific parameter of a vehicle as a function of an operating person, comprising the steps of:
sending personalization information of the operating person by a key of the vehicle to a control device of the vehicle, and
adjusting at least one parameter of the vehicle by the control device as a function of the received personalization information.

2. The method according to claim 1, comprising the step of determining the personalization information by determining and evaluating a biometric feature of the operating person.

3. The method according to claim 1, wherein the biometric feature of the operating person is a fingerprint and/or an acoustic feature of the speech of the operating person and/or an optical feature of the iris of the operating person.

4. The method according to claim 1, wherein the parameter of the vehicle to be adjusted is the adjustment of a seat, especially the driver's seat, and/or the adjustment of a mirror and/or a selection of transmitters stored in a radio receiver and/or acoustic adjustments of a music playback device and/or a parameter that influences the response behavior of the engine to control interventions of the operator.

5. The method according to claim 1, wherein the at least one operating person-specific parameter of the vehicle is only adjusted if a central locking device of the vehicle is unlocked by means of a locking activation element of the key, and/or an immobilizer of the vehicle is deactivated.

6. A key for a vehicle, wherein the key is configured, so that it sends personalization information of an operating person to a control device of the vehicle, and that the control device adjusts at least one parameter of the vehicle as a function of the received personalization information.

7. The key according to claim 6, wherein the key is configured, so that it determines the personalization information by determining and evaluating a biometric feature of an operating person.

8. The key according to claim 6, wherein the key is configured, so that it stores the personalization information.

9. The key according to claim 6, wherein the key is configured, so that the key sends the personalization information to the vehicle as soon as a communications connection is made between key and the vehicle.

10. The key according to claim 6, wherein the key has a locking activation element to lock or unlock a central locking device in vehicle and/or for activation or deactivation of an immobilizer of the vehicle.

11. The key according to claim 10, wherein the key is configured, so that it determines the biometric feature and therefore the personalization information and sends it to the vehicle, if the locking activation element is operated.

12. The key according to claim 11, wherein the locking activation element includes a fingerprint sensor, and that the key is configured, so that during operation of the locking activation element, a fingerprint is determined as diametric feature of the operating person by a fingerprint sensor.

13. The key according to claim 6, wherein the key is configured, so that the key determines information concerning the direction in which the vehicle is located viewed from the key, and displays the determined direction information.

14. The key according to claim 13, wherein the alignment of a bit of the key is used as reference direction of the key.

15. The key according to claim 13, wherein the key is configured, so that the key determines information concerning direction, in which the vehicle is located from the key only during activation of a vehicle locating activation element.

16. The key according to claim 6, wherein the key is configured, so that it sends the personalization information to the vehicle in wireless fashion, via contact connection, via inductive coupling or via a light signal.

17. The key according to claim 6, wherein the key is configured, so that it can receive status data from the vehicle.

18. The key according to claim 17, wherein the status data includes the mileage of vehicle and/or the filling of the fuel tank of the vehicle and/or information concerning whether unauthorized persons have entered the vehicle and/or operated it and/or information as to whether the vehicle is being moved or towed.

19. The key according to claim 17, wherein the key comprises a display to display the status data and a button, wherein the button is configured, so that the display can be activated by pressing the button.

20. The key according to claim 19, wherein the key is configured such that when pressing the button for the first time, information concerning the general status of the vehicle is displayed.

21. The key according to claim 20, wherein the key is configured, so that the information concerning the general status of the vehicle is information as to whether all status data is satisfactory or not, and includes an indication concerning a name corresponding to the personalization information that is stored in the key.

22. The key according to claim 18, wherein the key is configured, so that pressing of a button, when display is activated, causes the display to indicate a different part of the status data sent to the key from the vehicle with each pressing, in which, on repeated pressing of the button, all the status data sent from the vehicle are indicated on the display in succession.

23. The key according to claim 6, wherein the key is configured, so that different security steps are adjustable in the key, which stipulate the dependence on a determined biometric feature, in which the operating person can perform operating activities.

24. The key according to claim 6, wherein the key is configured, so that the key has an interface, by means of which a biometric feature with corresponding personalization information can be sent to the key.

25. The key according to claim 6, wherein the key is configured, so that the key has an interface, by means of which the personalization information can be transmitted to the key, and that the key in this case stores the transmitted personalization information.

26. A vehicle with an assigned key according to claim 6, in which the vehicle and the key have means of transmission and receipt for data transmission and are set up, so that the key sends personalization information of the operating person to a control device of the vehicle, and that the control device adjusts the at least one parameter of the vehicle as a function of the received personalization information.

27. The vehicle according to claim 26, wherein the vehicle is configured, so that the vehicle with key has a communications connection, when the vehicle recognizes that a handle of the vehicle is operated.

28. The vehicle according to claim 26, wherein the vehicle is configured, so that it transmits status data to the key.

29. The vehicle according to claim 26, wherein the vehicle is configured, so that it sends status data to the key at certain time intervals.

30. The vehicle according to claim 28, wherein the vehicle is configured, so that the status data are transmitted at the time of stopping of the vehicle or when the operating person leaves the vehicle.

31. The vehicle according to claim 28, wherein the vehicle sends status data in wireless fashion, by contact connection, inductive coupling or light signals.

32. The vehicle according to claim 26, wherein the vehicle and key are set up to execute a method comprising the steps of:
sending personalization information of the operating person by a key of the vehicle to a control device of the vehicle, and
adjusting at least one parameter of the vehicle by the control device as a function of the received personalization information.

33. The vehicle according to claim 26, wherein the means of transmission and receipt of the vehicle and the key are equipped for wireless data transmission.
